(19) United States
(12) Patent Application Publication
(10) Pub. No.: US 2024/0302969 A1
(43) Pub. Date: Sep. 12, 2024

(54) MEMORY CONTROL DEVICE AND MEMORY CONTROL METHOD

(71) Applicant: SONY SEMICONDUCTOR SOLUTIONS CORPORATION, KANAGAWA (JP)

(72) Inventor: TAKAHIRO IKARASHI, KANAGAWA (JP)

(21) Appl. No.: 18/258,349

(22) PCT Filed: Dec. 13, 2021
(86) PCT No.: PCT/JP2021/045827

§ 371 Date: Jun. 20, 2023

(30) Foreign Application Priority Data
Dec. 28, 2020 (JP) 2020-218395

(51) Int. Cl. G06F 3/06

(52) U.S. Cl. CPC G06F 3/0613; G06F 3/0659; G06F 3/0673

(57) ABSTRACT

A memory control device (20) includes an arbiter (21) that accepts an access request to a memory (10) including a plurality of bank groups each of which has a plurality of banks, and a memory controller (23) that issues a command corresponding to the access request accepted by the arbiter (21), and in a case where the arbiter (21) accepts an access request to a first bank group of the plurality of bank groups, the arbiter (21) suspends acceptance of another access request to the first bank group.

### FIELD

The present disclosure relates to a memory control device and a memory control method.

### BACKGROUND

A memory including a plurality of bank groups each having a plurality of banks is known (see, for example, Patent Literature 1).

### CITATION LIST

### Patent Literature

Patent Literature 1: JP 2006-99295 A

### SUMMARY

### Technical Problem

Data transfer efficiency may decrease due to, for example, restrictions on an issuance interval between commands to the same bank group. This point is not specifically studied in Patent Literature 1.

According to one aspect of the present disclosure, a memory control device and a memory control method that make it possible to prevent a decrease in data transfer efficiency are provided.

### Solution to Problem

A memory control device according to one aspect of the present disclosure comprises: an arbiter that accepts an access request to a memory including a plurality of bank groups each of which has a plurality of banks; and a memory controller that issues a command corresponding to the access request accepted by the arbiter, wherein in a case where the arbiter accepts an access request to a first bank group of the plurality of bank groups, the arbiter suspends acceptance of another access request to the first bank group.

A memory control method according to one aspect of the present disclosure comprises: accepting, by an arbiter, an access request to a memory including a plurality of bank groups each of which has a plurality of banks; and issuing, by a memory controller, a command corresponding to the access request accepted by the arbiter, wherein in a case where the arbiter accepts an access request to a first bank group of the plurality of bank groups, the arbiter suspends acceptance of another access request to the first bank group.

### BRIEF DESCRIPTION OF DRAWINGS

FIG. 1 is a diagram illustrating an example of a schematic configuration of a memory system.

FIG. 2 is a diagram illustrating an example of a bank group constitution.

FIG. 3 is a diagram schematically illustrating an example of an operation of a first method.

FIG. 4 is a diagram schematically illustrating an example of an operation of the first method.

FIG. 5 is a flowchart depicting an example of processing (memory control method) executed in the first method.

FIG. 6 is a diagram schematically illustrating an example of an operation of a comparative example.

FIG. 7 is a diagram schematically illustrating an example of an operation of the first method.

FIG. 8 is a flowchart depicting an example of processing (memory control method) executed in a second method.

FIG. 9 is a diagram schematically illustrating an example of a frequency of access requests.

FIG. 10 is a diagram schematically illustrating an example of a frequency of access requests.

FIG. 11 is a flowchart depicting an example of processing (memory control method) executed in a third method.

FIG. 12 is a diagram schematically illustrating an operation of a comparative example.

FIG. 13 is a diagram schematically illustrating an operation of a comparative example.

FIG. 14 is a diagram schematically illustrating an example of an operation of the third method.

### DESCRIPTION OF EMBODIMENTS

Hereinafter, embodiments of the present disclosure are described in detail with reference to the drawings. In the following embodiments, the same parts are denoted with the same reference numerals and repeated explanation of these parts is omitted.

The present disclosure is described in the following order of items.
1. Introduction
2. Embodiment
2.1 Example of first method
2.2 Example of second method
2.3 Example of third method
3. Modification example
4. Effects

### 1. Introduction

Along with acceleration of speed of a dynamic random access memory (DRAM), the number of banks is increased, which makes it possible to hide overhead of open and close of a page that is a drawback of a DRAM memory cell and to successively perform WRITE/READ. The method is called bank interleaving, or the like.

In recent years, a bank group is employed in which banks are divided into a plurality of (for example, four) groups, which doubles a data transfer band of input/output (I/O) without increasing the number of pieces of data read in parallel from a memory cell array while maintaining the number of pieces of data. The minimum unit is called a burst length of 16 and a burst length of 32 in which two prefetches are successively performed, and is designated when a WRITE/READ command is issued.

In principle, only commands having a burst length of 16 are successively issued and, from a microscopic perspective, data transfer efficiency of 100% (a state in which there is no time not to transfer data and data is always transferred from a data pin) can be achieved. However, in a case where bank group interleaving is not performed and access requests (sometimes referred to as “requests” simply) to the same bank group follow one after the other, the data transfer efficiency is only 50% at the maximum, independent of the burst length. In order to avoid this, for example, it is necessary to issue WRITE/READ commands while bank group switching is performed. In address mapping to convert a logical address for a case where a master makes an access request to a physical address, in the case of a sequential access (that is, an access is made while the address is incremented), as a conventional example, a DRAM has been efficiently used by mapping in the order of a column address, a bank address, and a row address from an address least significant bit (LSB). Further, in a case where an address space is divided into a plurality of channels, it is necessary to allocate each channel identification bit to somewhere. In a case where the bank group interleaving is necessary, it is necessary to allocate a bank group bit immediately above a bit corresponding to a burst length of 16 in the column address.

Systems in which two or more masters share a memory are very widely used in a system-on-a-chip (SoCs), which usually requires a large scale memory space. The “large scale” means a large capacity and a high bandwidth, and in a case where a high bandwidth is necessary, a synchronous dynamic random access memory (SDRAM) is known as a device that meets price and performance requirements, and it is said that a higher bandwidth memory will be required in the future. As a specific implementation method, the large scale memory space is implemented by a physical memory, and the same address command data input/output interface is shared. The memory space may be managed by system specific firmware that controls hardware, or may be managed by a memory control mechanism dynamically secured by the OS. The important thing is that an address space used by two or more masters is explicitly determined at the point in time when the master accesses a memory, and the involvement of an arbiter and a memory controller mentioned in the present disclosure is not essential to determine the address space.

For example, an SoC that requires a higher bandwidth memory needs a high frequency, also needs a highly reliable signal transmission/reception I/O and an advanced substrate design, and such an SoC is costly to design, evaluate, and operate. Since a high bandwidth memory is used at a high cost, it is possible to increase the processing capabilities of the SoC and increase the added value by increasing the data transfer efficiency as much as possible and performing effective data transfer. In addition, if the data transfer efficiency is increased so that necessary data transfer can be performed even at a low frequency, the SoC can be operated with low power consumption. Thus, increasing the data transfer efficiency is expected to be profitable.

In order to increase the data transfer efficiency, it is necessary to find out in what cases the data transfer efficiency is reduced and what factors are responsible for the reduction. Factors preventing the data transfer include: a time at which a command (REFpb, REFab, etc.) necessary for data retention other than data transfer (WRITE, READ) is issued; a time at which a command (ACT, PREpb) necessary for preparation for data transfer is issued; and a time at which a data transfer command cannot be issued because of restrictions that an interval between commands needs to be longer than a predetermined interval. Burst transfer is performed in which data read out in parallel from a memory cell is subjected to P/S conversion and sequentially transferred from a data I/F; therefore, the data transfer efficiency can be maintained at 100% even if a data transfer command is not always issued. The following restrictions are imposed: in a command clock, if 50% of the command having a burst length of 16 can be filled with a data transfer command, and if 25% of the command having a burst length of 32 can be filled with a data transfer command, then the data I/F can maintain a data transfer efficiency of 100%; and conversely, the data transfer command cannot be issued at a higher frequency. For example, the disclosed technology can be useful in order to further increase the data transfer efficiency while such requirements and restrictions are satisfied.

The disclosed technology relates to command issuance scheduling in consideration of bank groups and, if necessary, also in consideration of collision of command issuance, burst lengths, and the like. The disclosed technology can be useful particularly for a case where clock frequencies of commands and data are different, burst lengths are not limited to one type, and so on.

### 2. Embodiment

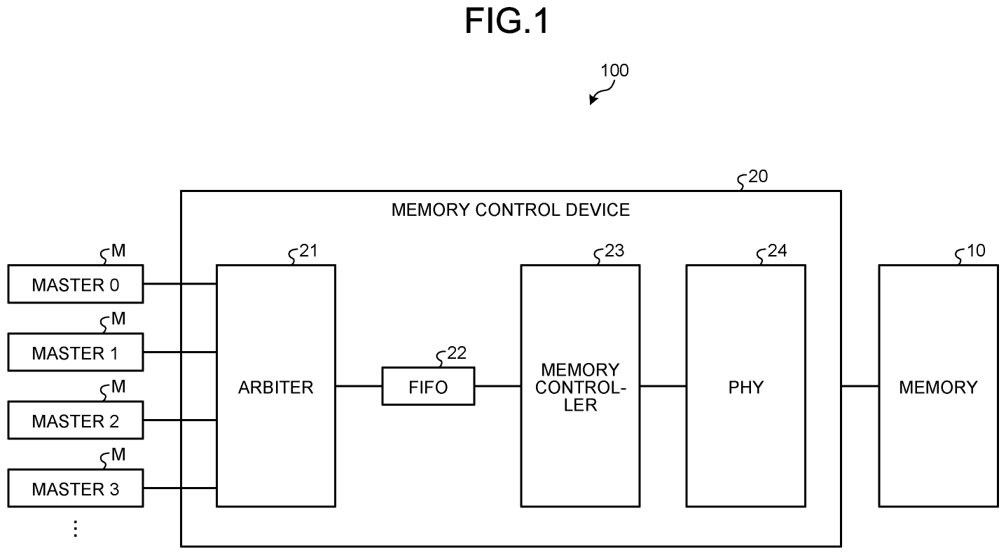

FIG. 1 is a diagram illustrating an example of a schematic configuration of a memory system in which a memory control device according to an embodiment is used. A memory system 100 includes a memory 10, a master M, and a memory control device 20. In this example, the memory system 100 includes a plurality of masters M which are referred to as a master 0, a master 1, a master M, and a master 3 so as to be distinguishable from one another. Note that the number of masters M is not limited to the example illustrated in FIG. 1.

The memory 10 is, for example, a DRAM or an SDRAM, and includes a plurality of bank groups each having a plurality of banks.

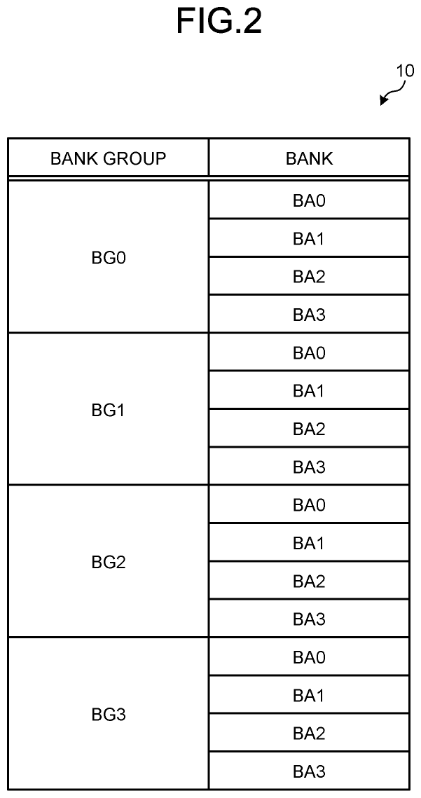

FIG. 2 is a diagram illustrating an example of a bank group constitution. In this example, the memory 10 includes four bank groups of a bank group BG0, a bank group BG1, a bank group BG3, and a bank group BG3. Each bank group includes four banks of a bank BA0, a bank BA1, a bank BA2, and a bank BA3. Note that the number of bank groups and the number of banks included in the memory 10 are not limited to the example illustrated in FIG. 2.

Returning to FIG. 1, the master M issues an access request to the memory 10 and transmits the access request to the memory control device 20. Examples of the master M include a CPU, a DMAC, a Pcle, and an ISP.

The access request issued by the master M includes addressing in the memory 10 in addition to request contents such as WRITE/READ. The address is identified by, for example, a bank group, a bank, a row, and a column. The access request follows a predetermined protocol. Examples of the protocol include an advanced high-performance bus (AHB), an advanced extensible interface (AXI), and an open core protocol (OCP).

The memory control device 20 is provided between the master M and the memory 10. The memory control device 20 issues a command corresponding to the access request made from the master M. Examples of the command include a READ command and a WRITE command. In addition, various commands such as an ACT command, a PREpb command, and a REFpb command are issued as necessary.

The memory control device 20 includes an arbiter 21, a first in first out (FIFO) 22, a memory controller 23, and a PHY 24.

The arbiter 21 arbitrates the access request made from the master M. An example of the arbitration is to determine the order in which a plurality of access requests is accepted, and the details will be described later again. The arbiter 21 outputs (pushes) the accepted access requests to the FIFO 22.

The FIFO 22 stores, in order, the access requests accepted by the arbiter 21. The access requests stored in the FIFO 22 are retrieved (popped) by the memory controller 23 in the order in which the access requests have been stored.

The memory controller 23 issues commands corresponding to the access requests on the basis of the arbitration result of the arbiter 21. To be specific, the memory controller 23 retrieves the access request from the FIFO 22 in which the access requests are stored in the order in which the arbiter 21 has accepted, and issues a command corresponding to the retrieved access request. The memory controller 23 transmits the issued command to the PHY 24.

The PHY 24 is provided between the memory controller 23 and the memory 10. The PHY 24 is a physical layer interface, and converts the command issued by the memory controller 23 to a physical quantity. For example, the PHY 24 causes an electric signal (voltage signal or the like) corresponding to the command at a terminal (parallel terminal, for example) of an unillustrated IC or the like. The electric signal is sent to the memory 10.

The memory 10 operates in accordance with the command issued by the memory controller 23, more specifically, the electric signal sent from the PHY 24. For example, an ACT command is issued, so that the access destination bank transitions to an activate state (from an idle state). A READ command is issued, so that data is transferred from the memory 10 to the master M.

The memory control device 20 controls the memory 10 on the basis of various clocks. A control operation clock for the memory controller 23 is referred to as a command clock. A data transfer operation clock for the memory 10 is referred to as a data clock. A command clock frequency may be lower than a data clock frequency. An example of the ratio between the command clock frequency and the data clock frequency is 1:4 and, for example, the command clock frequency is 800 MHZ and the data clock frequency is 3200 MHZ. Note that command issuance scheduling may be parallelized into N (N is an integer of 2 or more), and in this case, the control of the memory controller 23 may be synchronized with a clock frequency of 1/N of the command clock frequency.

Note that an operation clock for the arbiter 21 may be arbitrarily set as long as the FIFO 22 supports an asynchronous clock. The frequency of the operation clock for the arbiter 21 is set to be, for example, the same clock frequency as that of the CPU system having strict latency requirements from an access request to data, or the same clock frequency as that of the master M having the largest data width, and so on. Note that, unless otherwise noted, the description will be given assuming that the frequency of the operation clock for the arbiter 21 is ½ (400 MHZ, for example) of the command clock frequency.

As mentioned at the beginning, there are some factors that reduce the data transfer efficiency of the memory 10. In the memory control device 20 according to the embodiment, the reduction in data transfer efficiency is prevented by the following method.

### 2.1 Example of First Method

As described above, in a case where there are a plurality of access requests made from a plurality of masters M, the arbiter 21 determines the order in which the access requests are accepted. In a case where all the access destinations are in the idle state, a command can be issued at the shortest time even if any of the access requests is accepted; therefore, there is no need to determine the order. However, if this is not the case, it is desirable to preferentially accept an access request for which a corresponding command can be quickly issued, in terms of increasing the data transfer efficiency.

For example, there is a case where immediate issuance of an ACT command corresponding to a further access request to (a row address of a different bank or the like of) a bank group which is in an active state in response to an ACT command issued immediately before is prohibited, due to restrictions or the like. Under such restrictions, it is necessary to issue a PREpb command once and issue the ACT command after returning from the pre-charging state to the idle state, which takes time. In this case, it is desirable to preferentially accept an access request to another bank group for which a corresponding command can be quickly issued. For example, depending on the restrictions, in a case where a WRITE command is issued to the same bank group as the bank group for which a WRITE command has been issued immediately before, it is required to secure an issuance interval between commands of a certain period (first period (tCCD_L)). On the other hand, a WRITE command to another bank group is only required to secure an issuance interval between commands of a period (second period (tCCD_S)) shorter than the first period (tCCD_L). The same applies to a READ command.

Therefore, in the first method, in a case where acceptable (selectable) access requests include only an access request to the same bank group as the bank group for which a command has been issued immediately before, the arbiter 21 suspends the acceptance of the access request. Meanwhile, in a case where an access request to a different bank group is made, the arbiter 21 accepts the access request. That is, when accepting an access request to a first bank group of the plurality of bank groups, the arbiter 21 suspends the acceptance of another access request to the first bank group. When accepting an access request to a bank group other than the first bank group, the arbiter 21 cancels the suspension.

The period of suspension may be set to be the same as the first period (tCCD_L). The arbiter 21 may count the period of suspension. In that case, when accepting an access request to the first bank group, the arbiter 21 starts a count indicating that the first bank group is in a busy state. An example of the busy state is a state in which an ACT/PRE operation (tRAS, tRPpb, tRCD) is required. The arbiter 21 cancels the suspension in response to the count value reaching a predetermined value. The predetermined value is set corresponding to the period of suspension.

The period of suspension may be set to a period until the data amount of the access requests accumulated in the FIFO 22 falls below a predetermined data amount (threshold). The access requests accumulated in the FIFO 22 are retrieved (popped) by the memory controller 23 when time elapses; therefore, the access requests are not permanently deadlocked.

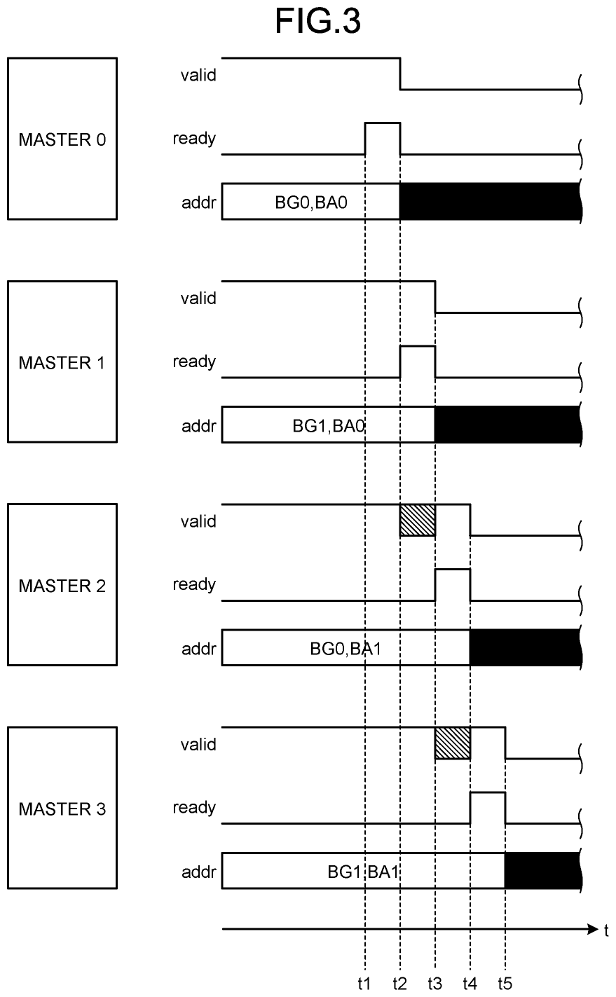

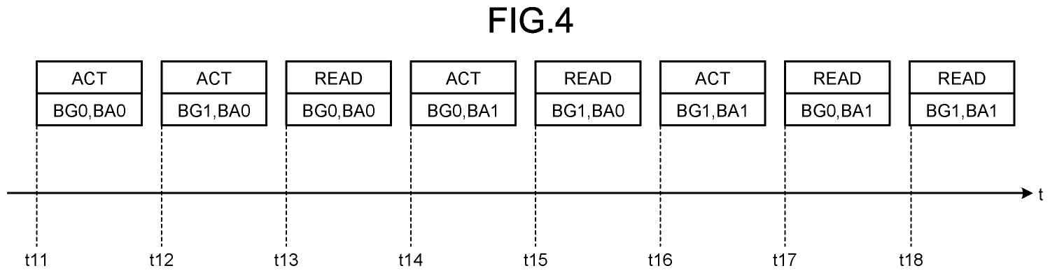

The suspension is performed by masking an access request. That is, the arbiter 21 ignores an access request made from the master M only for a masked period. This is described with also reference to FIGS. 3 and 4. FIGS. 3 and 4 are diagrams schematically illustrating an example of an operation of the first method.

FIG. 3 schematically illustrates an example of a timing to accept an access request. The horizontal axis represents a time t. The term “valid” represents an access request issuance state, and when “valid” is high, an access request is being made (asserted). The term “ready” represents the acceptance of an access request by the arbiter 21, and when “ready” is high, an access request is accepted. The term “addr” represents an address, and a bank group and a bank are exemplified in the drawing among elements identifying an address.

In this example, a target of an access request made from the master 0 is an access request to the bank BA0 of the bank group BG0. A target of an access request made from the master 1 is the bank BA0 of the bank group BG1. A target of an access request made from the master 2 is the bank BA1 of the bank group BG0. A target of an access request made from the master 3 is the bank BAL of the bank group BG1.

From time t1 to time t2, the arbiter 21 accepts the access request made from the master 0 to the bank group BA0 of the bank group BG0.

At time t2, the arbiter 21 masks the access request to the bank group BG0. In this example, the access request made from the master 2 to the bank BAL of the bank group BG0 is masked as illustrated by hatching. The arbiter 21 does not accept (suspends the acceptance of) the access request made from the master 2.

From time t2 to time t3, the arbiter 21 accepts the access request made from the master 1 to the bank BA0 of the bank group BG0.

At time t3, the arbiter 21 unmasks the access request to the bank group BG0. That is, the mask for the access request made from the master 2 is removed. Along with this, the arbiter 21 masks the access request to the bank group BG1. In this example, the access request made from the master 3 to the bank BA1 of the bank group BG1 is masked. The arbiter 21 does not accept the access request made from the master 3.

From time t3 to time t4, the arbiter 21 accepts the access request made from the master 2 to the bank BAL of the bank group BG0.

At time t4, the arbiter 21 unmasks the access request to the bank group BG1. That is, the mask for the access request made from the master 3 is removed. Note that, although not illustrated in the drawing, if there is an access request to the bank group BG0 from another master at this time, the arbiter 21 masks again the access request to the bank group BG0.

From time t4 to time t5, the arbiter 21 accepts the access request made from the master 3 to the bank BA1 of the bank group BG1.

FIG. 4 schematically illustrates an example of a timing to issue a command. Among commands to be issued, an ACT command and a READ command are exemplified.

At time t11, the memory controller 23 issues an ACT command to the bank group BA0 of the bank group BG0. The ACT command corresponds to the access request made from the master 0 accepted from time t1 to time t2 in FIG. 3.

At time t12, the memory controller 23 issues an ACT command to the bank BA0 of the bank group BG1. The ACT command corresponds to the access request made from the master 1 accepted from time t2 to time t3 in FIG. 3.

At time t13, the memory controller 23 issues a READ command to the bank BA0 of the bank group BG0. The READ command is a command subsequent to the ACT command issued at the previous time t11, and corresponds to the access request made from the master 0 accepted from time t1 to time t2 in FIG. 3.

At time t14, the memory controller 23 issues an ACT command to the bank BAL of the bank group BG0. The ACT command corresponds to the access request made from the master 2 accepted from time t3 to time t4 in FIG. 3.

At time t15, the memory controller 23 issues a READ command to the bank BA0 of the bank group BG1. The READ command is a command subsequent to the ACT command issued at the previous time t12, and corresponds to the access request made from the master 1 accepted from time t2 to time t3 in FIG. 3.

At time t16, the memory controller 23 issues an ACT command to the bank BAL of the bank group BG1. The ACT command corresponds to the access request made from the master 3 accepted from time t4 to time t5 in FIG. 3.

At time t17, the memory controller 23 issues a READ command to the bank BAL of the bank group BG0. The READ command is a command subsequent to the ACT command issued at the previous time t14, and corresponds to the access request made from the master 2 accepted from time t3 to time t4 in FIG. 3.

At time t18, the memory controller 23 issues a READ command to the bank BAL of the bank group BG1. The READ command is a command subsequent to the ACT command issued at the previous time t16, and corresponds to the access request made from the master 3 accepted from time t4 to the time t5 in FIG. 3.

For example, as described above, the arbiter 21 masks access requests to the same bank group so that access requests to the same bank group are not accepted successively. This secures an issuance interval between commands to the same bank group.

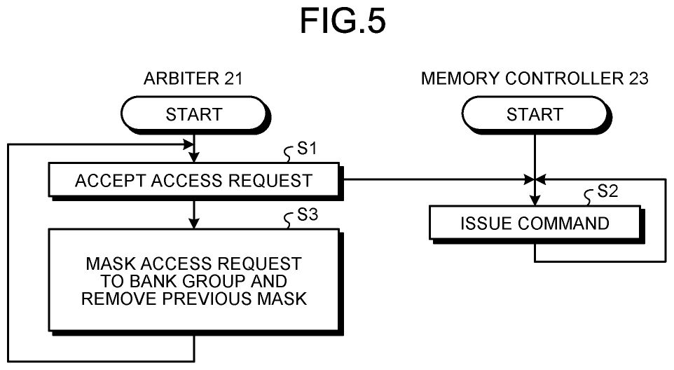

FIG. 5 is a flowchart depicting an example of processing (memory control method) executed in the first method.

In Step S1, the arbiter 21 accepts an access request made from the master M. For example, the arbiter 21 accepts an access request made from the master 0 to the bank group BG0. The access request accepted is accumulated in the FIFO 22 and retrieved by the memory controller 23.

In Step S2, the memory controller 23 issues a command. For example, the memory controller 23 issues a command corresponding to the access request made from the master 0 to the bank group BG0.

In Step S3, the arbiter 21 masks the access request to the bank group and removes the previous mask. For example, the arbiter 21 masks the access request to the bank group BG0. For example, in a case where the access request to the bank group BG1 is accepted in Step S1 of the previous flow and the access request to the bank group BG1 is masked in Step S3, the arbiter 21 unmasks the access request to the bank group BG1.

For example, the processing of Steps S1 to S3 is repeatedly executed, which prevents commands for the same bank group from being issued successively. As a result, it is possible to secure an issuance interval between commands to the same bank group.

An example of improvement in data transfer efficiency will be described. It is assumed that a loss caused by inefficiently accepting access requests is an L cycle per 100 cycles. In the conventional method, the data transfer efficiency is obtained by calculating 100/(100+L). In contrast, according to the method of the embodiment, for example, in a case where data transfer for an E cycle per (100+L cycles) can be performed, the data transfer efficiency is obtained by calculating (100+E)/(100+L), and the data transfer efficiency is increased as compared with the conventional method. When E>L, the data transfer efficiency is 100%.

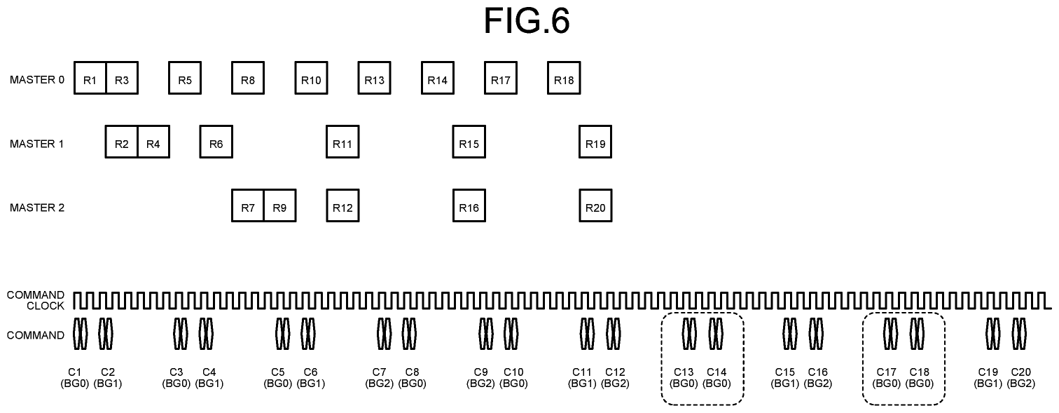

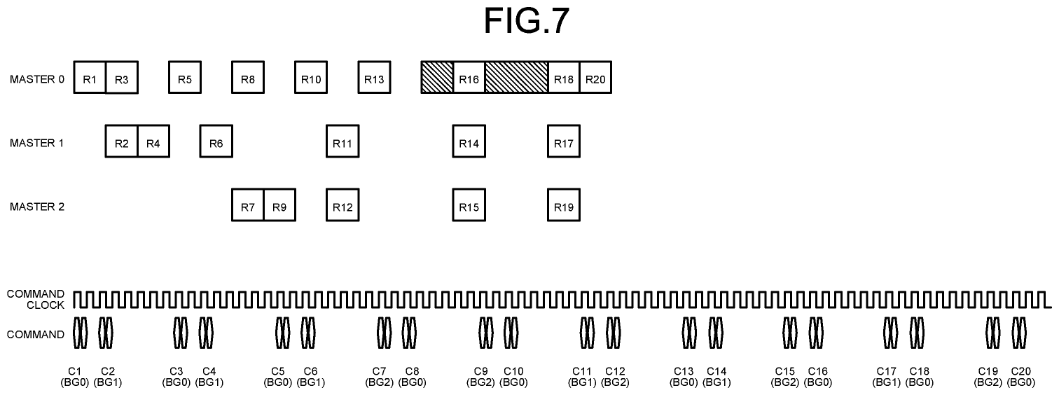

An example of the effect will be further described with reference to FIGS. 6 and 7. FIG. 6 is a diagram schematically illustrating an example of an operation of a comparative example. FIG. 7 is a diagram schematically illustrating an example of an operation of the first method.

FIG. 6 schematically illustrates an example of a timing to accept an access request and issue a command in the comparative example. For ease of understanding, only three masters of the master 0, the master 1, and the master 2 are illustrated. All the access requests made from the master 0 are assumed to be directed to the bank group BG0. All the access requests made from the master 1 are assumed to be directed to the bank group BG1. All the access requests made from the master 2 are assumed to be directed to the bank group BG2.

The access requests accepted, in order, by the arbiter 21 are referred to as an access request R1 to an access request R20 and illustrated in the drawing. Among them, the access request R1, the access request R3, the access request R5, the access request R8, the access request R10, the access request R13, the access request R14, the access request R17, and the access request R18 are access requests made from the master 0. The access request R2, the access request R4, the access request R6, the access request R11, the access request R15, and the access request R19 are access requests made from the master 1. The access request R7, the access request R9, the access request R12, the access request R16, and the access request R20 are access requests made from the master 2.

Commands issued, in order, corresponding to the access request R1 to the access request R20 are referred to as a command C1 to a command C20 and illustrated in the drawing. In this example, issuing each command requires two command clocks. Among the access requests made from the master 0, the access request R13 and the access request R14 are accepted successively, and the access request R17 and the access request R18 are also accepted successively. As a result, as illustrated in a broken line, the corresponding command C13 and command C14 are issued successively, and the command C17 and command C18 are also issued successively.

If there are restrictions that require eight command clocks to be secured in an issuance interval between commands, in the comparative example illustrated in FIG. 6, both an issuance interval between the command C13 and the command C14 and an issuance interval between the command C17 and the command C18 are shorter than the eight command clocks, and thus, the restrictions are not satisfied.

FIG. 7 schematically illustrates an example of a timing to accept an access request and issue a command in the first method. The restrictions that cannot be satisfied in the comparative example are satisfied. After accepting an access request 13 from the master 0 to the bank group BG0, the arbiter 21 masks (illustrated with hatching) the access request to the bank group BG0. During this period of time, the arbiter 21 does not accept an access request made from the master 0. Instead, the arbiter 21 accepts an access request R14 from the master 1 to the bank group BG1. Thereafter, the arbiter 21 accepts, in order, an access request R15 from the master 2 to the bank group BG2 and an access request R16 from the master 1 to the bank group BG1. Similarly, the arbiter 21 masks the access request to the bank group BG0, accepts an access request R17 from the master 1 to the bank group BG1, and then accepts again an access request R18 from the master 1 to the bank group BG1. Thereafter, the arbiter 21 accepts, in order, an access request R19 from the master 2 to the bank group BG2 and an access request R20 from the master 0 to the bank group BG0. As a result, an issuance interval between the command C13 and the command C14 corresponding to the access request R13 and the access request R14 respectively, and an issuance interval between the command C17 and the command C18 corresponding to the access request R17 and the access request R18 respectively are the eight command clocks or more, which satisfies the restrictions.

### 2.2 Example of Second Method

Returning to FIG. 1, the memory controller 23 will be further described. Although the operation of the memory controller 23 is well known, examples of some operations will be described for easier understanding. The memory controller 23 evaluates a state of a bank that is a target of an access request extracted from the FIFO 22. The state is evaluated on the basis of commands issued by the memory controller 23 until just before the evaluation.

For example, in a case where the evaluation result shows that the bank is in the idle state, the memory controller 23 issues an ACT command. This transitions the bank from the idle state to the bank activate state. Thereafter, the memory controller 23 further issues a WRITE command in a case where an access request is WRITE, and issues a READ command in a case where an access request is READ. In this manner, the memory controller 23 issues one or more commands in response to one access request.

The memory controller 23 includes a buffer (not illustrated) that holds a plurality of access requests extracted from the FIFO 22, and issues a mixture of a plurality of commands corresponding to the plurality of access requests (mixed in time series). For example, a WRITE command corresponding to an access request of a first buffer and an ACT command corresponding to an access request of a second buffer can be issued simultaneously.

That is, in the memory controller 23, issuance of a plurality of commands may conflict (may collide with each other). In this case, it is necessary to determine which command is given priority.

In light of the above, in the second method, the memory controller 23 determines priority of command issuance on the basis of statistical information of an access request. The statistical information is acquired when the arbiter 21 accepts (selects) an access request. The statistical information is information indicating a value calculated for a period when an access request is asserted for each bank group and/or for each bank. To be specific, the arbiter 21 calculates, for each bank group and/or for each bank, an assertion period from when an access request is made to when the access request is accepted. In a case where issuance of commands corresponding to a plurality of access requests collide with each other, the memory controller 23 preferentially issues a command corresponding to any of the access requests on the basis of the calculated value for the assertion period calculated by the arbiter 21. For example, the memory controller 23 preferentially issues a command corresponding to an access request having the largest calculated value for the assertion period among the plurality of access requests.

In a case where the statistical information indicates information for each bank group, for example, the arbiter 21 determines, for each bank group, a calculated value for the period during which the access request is asserted. The calculated value may be an added value in the period during which the access request is asserted. In a case where the access request follows AXI (an example of protocol), the arbiter 21 adds a period during which an AWVALID signal and an ARVALID signal are asserted (high, for example). The arbiter 21 subtracts a calculated value for a bank group for which none of the masters M make an access request, or resets (zeroes out) the calculated value.

If the calculated value exceeds a threshold, then the arbiter 21 notifies the memory controller 23 of the corresponding bank group. The notification may be performed by adding information to the access request via the FIFO 22, or may be performed on a channel different from the FIFO 22.

The memory controller 23 always prioritizes command issuance to the bank group notified by the arbiter 21. In a case where the command issuance timing is restricted by a standard or the like, the command may be issued at the shortest time to the extent it does not violate the restrictions.

In a case where the statistical information indicates information for each bank, the above description is made by replacing the bank group with the bank. To be specific, the arbiter 21 determines, for each bank, a calculated value for the period during which the access request is asserted. If the calculated value exceeds a threshold, then the arbiter 21 notifies the memory controller 23 of the corresponding bank. The memory controller 23 always prioritizes command issuance to the bank notified by the arbiter 21.

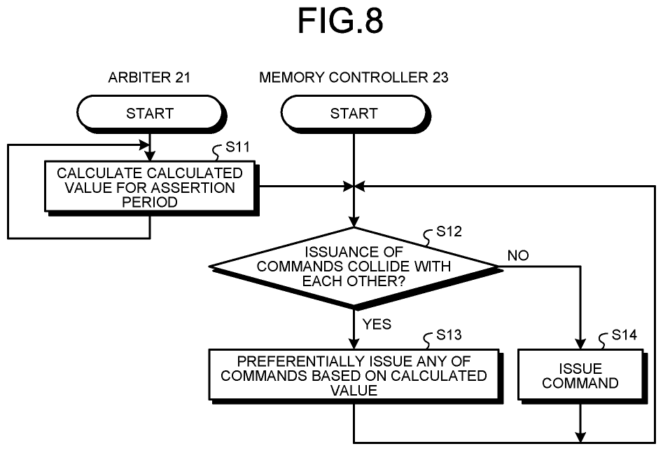

FIG. 8 is a flowchart depicting an example of processing (memory control method) executed in the second method.

In Step S11, the arbiter 21 calculates a calculated value for the assertion period. For example, the arbiter 21 calculates a calculated value for the assertion period for the access request for each of the bank group BG0 to the bank group BG3. The calculated value is sent to the memory controller 23. For example, the memory controller 23 is notified of a bank group for which the calculated value exceeds a threshold. The arbiter 21 may calculate a calculated value for the assertion period for the access request for each of the banks BA1 to BA3. In this case, a bank for which the calculated value exceeds a threshold is notified to the memory controller 23.

In Step S12, the memory controller 23 determines whether or not issuance of commands collide with each other. In a case where the issuance of commands collide with each other (Yes in Step S12), the processing proceeds to Step S13. Otherwise (No in Step S12), the processing proceeds to Step S14.

In Step S13, the memory controller 23 preferentially issues any of the commands on the basis of the calculated value. For example, in a case where the bank group BG0 is notified by the arbiter 21, the memory controller 23 preferentially issues a command corresponding to the access request to the bank group BG0. In a case where the bank BAL is notified by the arbiter 21, the memory controller 23 preferentially issues a command corresponding to the access request to the bank BA1.

In Step S14, the memory controller 23 issues a command. That is, in this case, since there is no collision of issuance of commands, the memory controller 23 issues, in order, commands as usual.

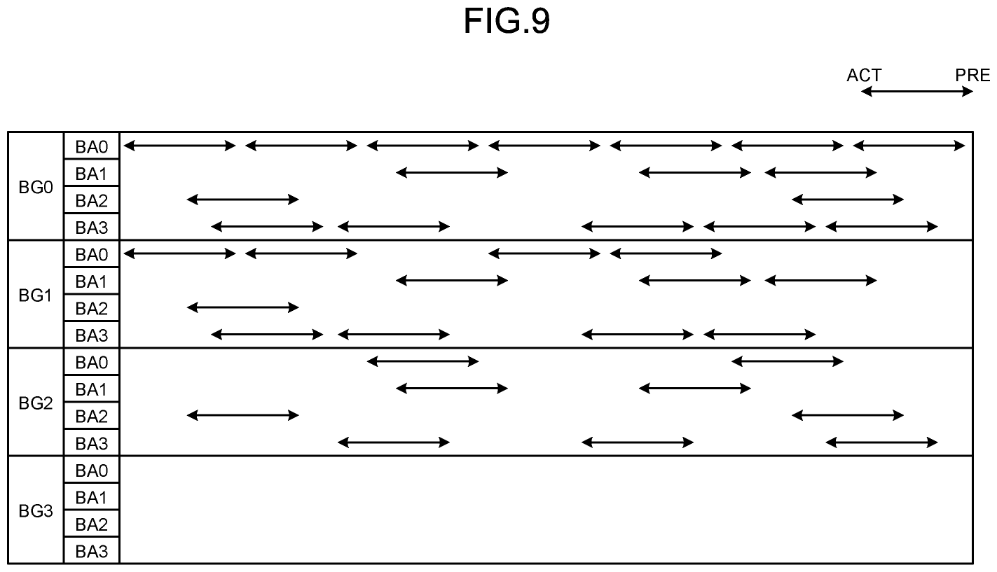

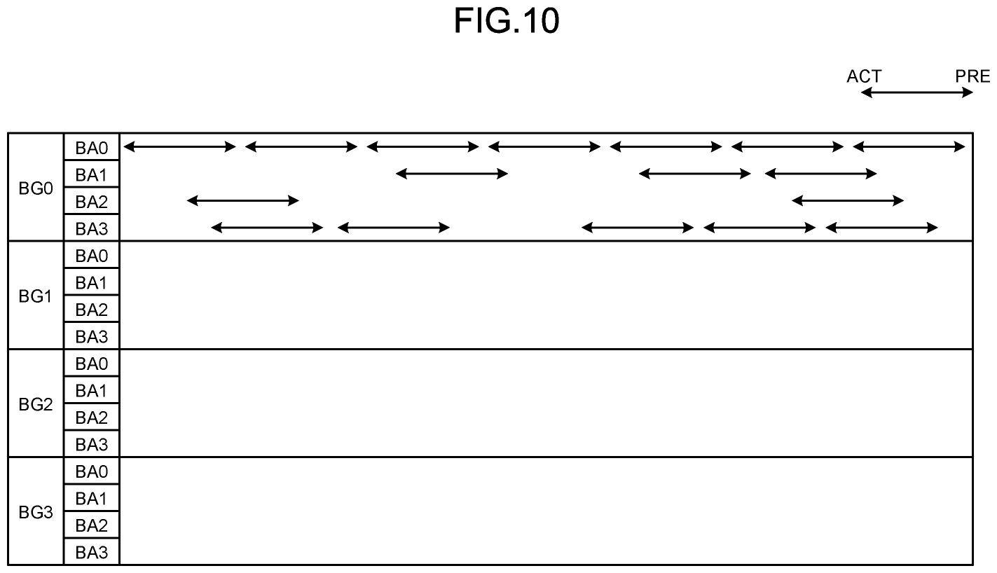

For example, the processing of Steps S11 to S14 is repeatedly executed, which gives priority to issuance of a command to a bank and/or bank group having a large deviation statistically. This prevents a decrease in data transfer efficiency. An example of the frequency of access requests will be described with also reference to FIGS. 9 and 10.

FIG. 9 schematically illustrates an example of the frequency of access requests for each bank group. In the diagram, an arrow indicates that the bank is in a busy state in which an ACT/PRE operation (tRAS, tRPpb, tRCD) is necessary. In this example, the frequency of access requests to the bank BA0 of the bank group BG0 is the highest among the banks. Therefore, the issuance of commands (ACT, WRITE, READ, PREpb) to the bank BA0 of the bank group BG0 is prioritized.

FIG. 10 schematically illustrates an example of the frequency of access requests for each bank. In this example, the frequency of access requests to the bank group BG0 is the highest among the bank groups. Therefore, the issuance of commands to the bank group BG0 is prioritized.

A specific example of the effect will be described. It is assumed that the frequency of issuance of an access request with a burst length of 32 is 50% for the bank group BG0, and is 25% for each of the bank group BG1 and the bank group BG2. According to the conventional method, in a case where commands are issued in the order of the bank group BG0, the bank group BG1, the bank group BG2, and the bank group BG0 . . . , the data transfer efficiency of the remaining bank group BG0 is 50%, and the overall efficiency is 80%. In contrast, according to the method of the embodiment, an access request to the bank group BG0 is always prioritized, and commands are issued in the order of the bank group BG0, the bank group BG1, the bank group BG0, the bank group BG2, the bank group BG0 . . . , and so on. In particular, although options for issuance of the third command are the bank group BG0 and the bank group BG2, issuance of the command to the bank group BG0 is prioritized. Although options for issuance of the fifth command are the bank group BG0 and the bank group BG1, issuance of the command to the bank group BG0 is prioritized. Thereafter, the processing is repeated in this manner, which results in a data transfer efficiency of 100%. 2.3 Example of third method

Returning to FIG. 1, the arbiter 21 may accept a plurality of access requests in order according to the burst length of each access request. Examples of the burst length include a burst length of 16 and a burst length of 32. Commands corresponding to access requests having any of the burst lengths have the same period (the number of command clocks) required to be issued.

The description will be provided of a correlation between an address of AXI, AHB, or the like as well as a data width and length in the form of an access request inputted to the arbiter 21 and an address (bank group, bank, row, column) of the memory 10. The address of AXI, AHB, or the like is generally a byte address, and in a case where the data width is 64 bits, the address is a multiple of eight, and in a case where the data width is 128 bits, the address is a multiple of 16.

Data is successively handled by an amount corresponding to the data width×length; therefore, in a case where the data width is 128 bits and the length is 16, 2048-bit data can be transferred in one access request. For example, in a case where the number of data pins per channel is 16, 256-bit data is transferred in a WRITE command with a burst length of 16. In the case of a WRITE command with a burst length of 32, 512-bit data is transferred. The same applies to a READ command.

For example, in a case where the data width is 128 bits and the length is 16, 2048-bit data can be transferred in one access request, but whether or not the data can be divided into burst lengths is determined depending on the start address. In a case where the address is a 512-bit alignment, that is, a multiple of 64 in the byte address, 2048-bit data can be transferred in four commands with a burst length of 32, such as 512+512+512+512. In a case where the address is not a 512-bit alignment but is a multiple of 32 in the byte address, 2048-bit data can be transferred in five commands with a burst length of 16 and a burst length of 32, such as 256+512+512+512+256.

It should be noted that the arbiter 21 or the memory controller 23 can uniquely determine whether the burst length is a burst length of 16 or a burst length of 32, from the address (of AXI, AHB, or the like) as well as the data width and length indicated in the access request. Thus, the division may be performed by any of a preceding stage of the arbiter 21, the arbiter 21, a preceding stage of the memory controller 23, and the memory controller 23. The important thing is that the arbiter 21 can find out whether an (acceptable) access request that is about to be selected is an access request that results in having a burst length of 16 or an access request that results in having a burst length of 32.

Therefore, in the third method, in a case where the access request selected (accepted) immediately before corresponds to (is designated as) a burst length of 16, the arbiter 21 prioritizes the access request that results in having a burst length of 32 as the access request to be selected next. To be specific, the arbiter 21 accepts, in the stated order, an access request for which the burst length for a burst transfer, which is performed when data is written to the memory 10 (WRITE) and data is read from the memory 10 (READ), results in having a first burst length (burst length of 16, for example) and an access request for which the burst length results in having a second burst length (burst length of 32, for example) longer than the first burst length, on the basis of the address, data width and length indicated in the access request. The third method can also be performed independently of the first method described above, and the third method is performed in combination with (in parallel with) the first method, which further enhances the data transfer efficiency.

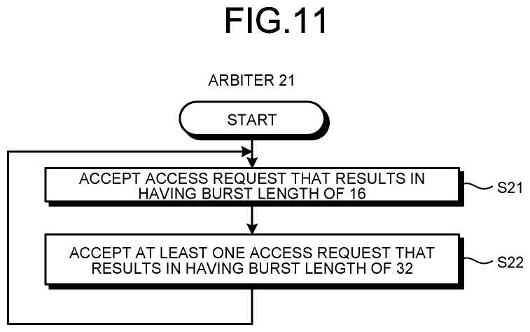

FIG. 11 is a flowchart depicting an example of processing (memory control method) executed in the third method. In Step S11, the arbiter 21 accepts an access request that results in having a burst length of 16. In Step S12, the arbiter 21 accepts at least one access request that results in having a burst length of 32. The data transfer efficiency can be further enhanced only by repeatedly executing the processing of Step S21 and Step S22.

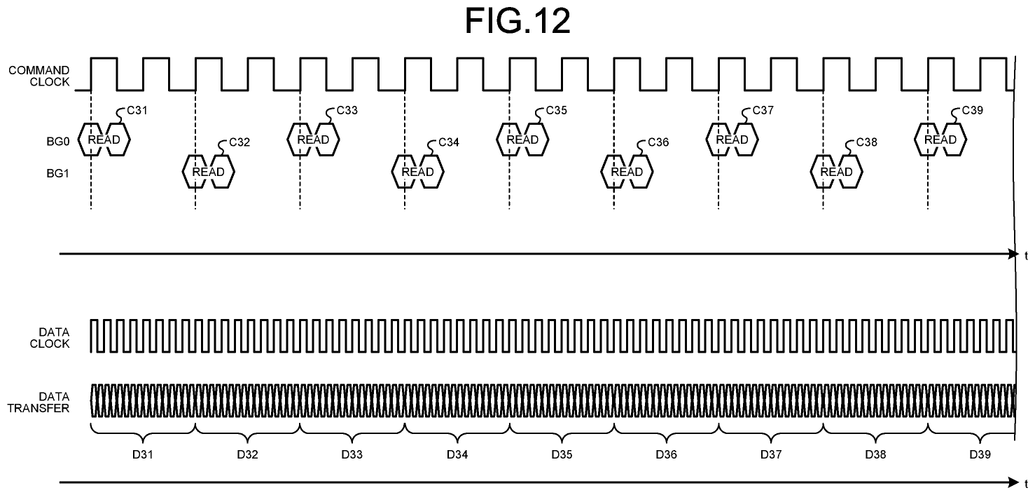

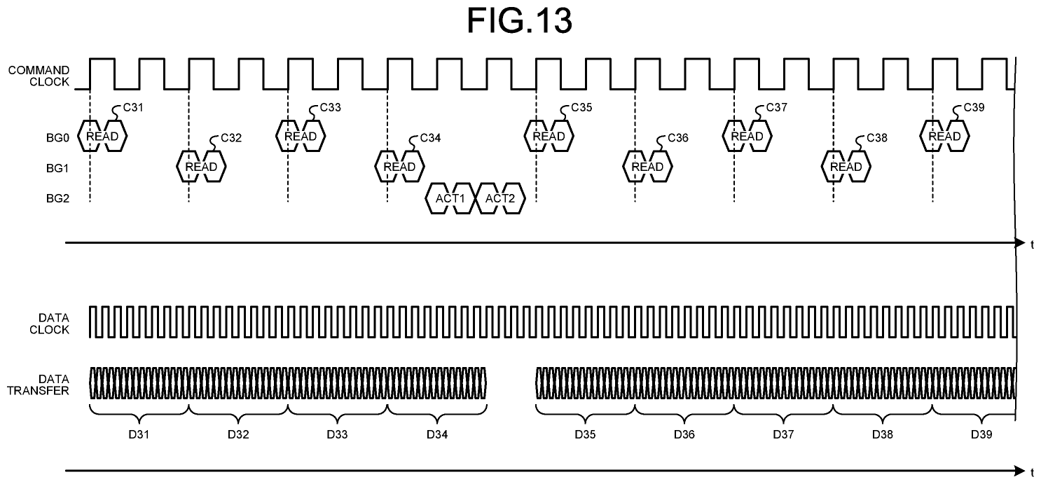

FIGS. 12 and 13 are diagrams schematically illustrating operations of comparative examples. Only a command corresponding to an access request that results in having a burst length of 16 is issued. From the viewpoint of easier understanding and the like, the description will be given assuming that read latency (RL) is 0 so that commands and availability of data transfer are illustrated side by side. In the comparative example illustrated in FIG. 12, a command C31, a command C33, a command C35, a command C37, and a command C39 for the bank group BG0, and a command C32, a command C34, a command C36, and a command C38 for the bank group BG1 are alternately issued at issuance intervals between commands (for example, tCCD_S). The entire (namely, 100%) of the data transfer band is occupied by data D31 to data D9 transferred in response to the commands. However, the band for command issuance is also full, and another command (for example, ACT command) cannot be issued. On the other hand, in the comparative example illustrated in FIG. 13, two ACT commands (ACT1 and ACT2) for the bank group BG2 are issued in order between the issuance of the command C34 and the issuance of the command C35. In a case where the two ACT commands are issued without intervals in this way, a band in which no data is transferred is present between the transfer of the data D34 and the transfer of the data D35; therefore, 100% of the data transfer band cannot be achieved.

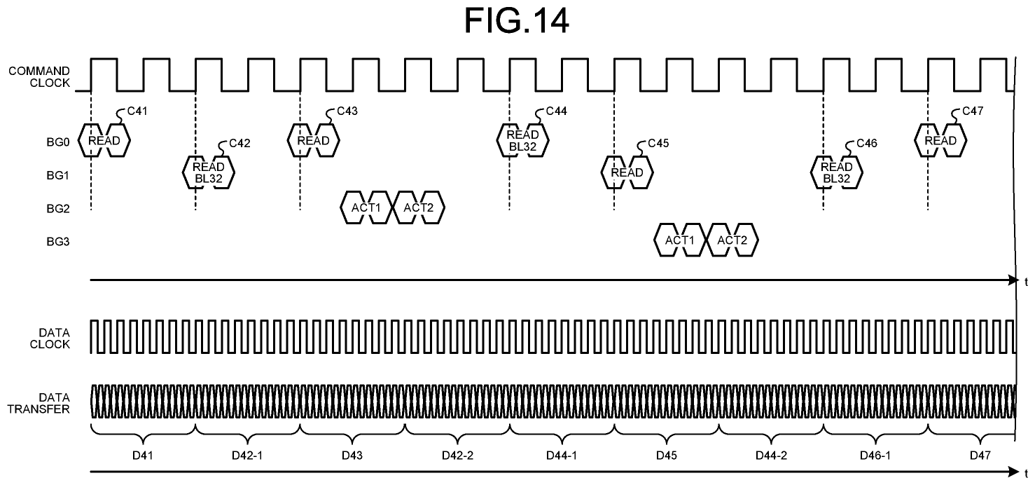

FIG. 14 is a diagram schematically illustrating an operation of the third method. Similarly to FIGS. 12 and 13 described above, the description will be given assuming that the read latency (RL)=0. As illustrated in FIG. 14, a command corresponding to an access request that results in having a burst length of 16 and a command corresponding to an access request that results in having a burst length of 32 (illustrated as “READBL 32”) are alternately issued.

Specifically, a command C41, a command C43, a command C44, and a command C47 are issued for the bank group BG0. The command C41, the command C43, and the command C47 are issued in response to access requests that result in having a burst length of 16. The command C44 is issued in response to an access request that results in having a burst length of 32. In response to these commands, data D41, data D43, data D44, and data D47 are transferred. The data D44 is divided into data D44-1 and data D44-2 and then transferred.

A command C42, a command C45, and a command C46 are issued for the bank group BG1. The command C45 is issued in response to an access request that results in having a burst length of 16. The command C42 is issued in response to an access request that results in having a burst length of 32. The command C46 may be issued in response to an access request that results in having any one of the burst lengths and, in this example, the command C46 is illustrated so as to respond to an access request that results in having a burst length of 32. In response to these commands, data D42, data D45, and data D46 are transferred. The data D42 is divided into data D42-1 and data D42-2 and then transferred. The same applies to the data D46.

In this example, an ACT command for the bank group BG2 is issued between the issuance of the command C43 and the issuance of the command C44. Even in this case, no band is present in which no data is transferred. In addition, an ACT command for the bank group BG3 is issued between the issuance of the command C45 and the issuance of the command C46. Even in this case, no band is present in which no data is transferred. As a result, 100% of the data transfer band can be achieved.

For example, as described above, the access requests that result in having a burst length of 16 do not concentrate, and the command corresponding to the access request that results in having a burst length of 32 is issued, whereby the ACT command can be issued. It is possible to prevent a penalty (for example, FIG. 12 described above) caused because no ACT command can be issued due to the concentration of access requests that result in having a burst length of 16, deterioration in data transfer efficiency (for example, FIG. 13 described above) caused by the issuance of an ACT command, and the like, as in the conventional method.

### 3. Modification Example

The present disclosure is not limited to the embodiment. Some modification examples will be described.

In the first method described above, a column of access requests (requested column) may be held in a buffer in a preceding stage of the arbiter 21 to reorder the access requests. For example, in a case where there are two or more bank groups, banks, and rows in the address (bank group, bank, row, column), the access requests may be reordered for successive issuance. This reduces the number of times that the PREpb commands and the ACT commands are issued, so that a data transfer command can be issued more quickly.

In the reordering, the arbiter 21 may divide the access requests into a plurality of hierarchies (in a tournament, for example) until the order is determined. For example, access requests from all of the masters M are classified, for each bank, in a first hierarchy, and an access request is selected. In a case where the number of banks is 16, a maximum of 16 access requests are selected. Next, the access requests selected in the first hierarchy are classified, for each bank group, in a second hierarchy, and an access request is selected. In a case where the number of bank groups is 4, a maximum of 4 access requests are selected. Finally, the order is determined among the access requests selected in the second hierarchy.

In the second method, the statistical information may be given to the arbiter 21 by the master M. The arbiter 21 may combine (incorporate into the calculation) the information given by the master M to obtain the overall statistical information.

In the second method, the statistical information may be given (returned) to the arbiter 21 by the CPU depending on the application. The arbiter 21 may combine the information given by the CPU with statistical information that the CPU itself accesses the arbiter 21 (e.g., a case where a program region is in the memory 10) to obtain the overall statistical information.

In the third method, the arranged access requests may be reordered again in the memory controller 23.

### 4. Effects

The memory control device 20 described above is specified as follows, for example. As described with reference to FIGS. 1 to 5, 7, and the like, the memory control device 20 includes the arbiter 21 that accepts an access request to the memory 10 including a plurality of bank groups each having a plurality of banks, and the memory controller 23 that issues a command corresponding to the access request accepted by the arbiter 21. When accepting an access request to the first bank group of the plurality of bank groups, the arbiter 21 suspends the acceptance of another access request to the first bank group (for example, masks the access request).

According to the memory control device 20, access requests to the same bank group are not successively accepted. For example, during that time, an access request to another bank group is accepted, so that a decrease in data transfer efficiency can be prevented while an issuance interval between commands to the same bank group is secured.

As described with reference to FIG. 3 and the like, when accepting an access request to a bank group other than the first bank group, the arbiter 21 may cancel the suspension (for example, unmask). As a result, it is possible to secure an issuance interval between commands to the same bank group.

When accepting an access request to the first bank group, the arbiter 21 may start a count indicating that the first bank group is in a busy state and cancel the suspension when the count value reaches a predetermined value. For example, in this manner, it is possible to secure an issuance interval between commands to the same bank group.

As described with reference to FIG. 1 and the like, the memory control device 20 includes the FIFO 22 that accumulates access requests accepted by the arbiter 21, the memory controller 23 retrieves the access requests accumulated in the FIFO 22 and issue commands corresponding to the retrieved access requests, and the arbiter 21 may cancel the suspension in a case where a data amount of the access requests accumulated in the FIFO 22 falls below a predetermined data amount. As a result, it is possible to secure an issuance interval between commands to the same bank group and prevent the suspension from being deadlocked.

As described with reference to FIG. 8 and the like, the arbiter 21 calculates, for at least each bank group, an assertion period from when an access request is made to when the access request is accepted and, in a case where issuance of commands corresponding to a plurality of access requests collides with each other, the memory controller 23 may preferentially issue a command corresponding to any one of the access requests on the basis of a calculated value for the assertion period calculated by the arbiter 21. The memory controller 23 may preferentially issue a command corresponding to an access request having the largest calculated value for the assertion period among the plurality of access requests. The arbiter 21 may calculate the assertion period for each bank. As a result, priority is given to command issuance to a bank group and/or bank having a large statistical deviation, and accordingly, a decrease in data transfer efficiency can be prevented.

As described with reference to FIGS. 11, 14, and the like, the arbiter 21 may accept, in the stated order, an access request for which a burst length results in having a first burst length (burst length of 16, for example) for a burst transfer performed when data is written to the memory 10 and data is read from the memory 10 and an access request for which the burst length results in having a second burst length (burst length of 32, for example) longer than the first burst length, on the basis of the address, the data width and length indicated in the access request. As a result, it is possible to prevent a decrease in data transfer efficiency and enable command issuance of an ACT command or the like as compared with a case of the concentration of access requests that result in having a first burst length.

The memory control method described with reference to FIG. 5 and the like is also an aspect of the present disclosure. To be specific, the memory control method includes accepting, by the arbiter 21, access requests to the memory 10 including a plurality of bank groups each of which has a plurality of banks (Step S1) and issuing, by the memory controller 23, commands corresponding to the access requests accepted by the arbiter 21 (Step S2), in which in response to an access request to the first bank group of the plurality of bank groups, the arbiter 21 suspends acceptance of another access request to the first bank group (masks the access request, for example) (Step S3). Such a memory control method can also prevent a decrease in data transfer efficiency as described above.

The effects described in the present disclosure are merely examples, and the effects are not limited to the disclosed contents. There may be other effects.

Although the embodiments of the present disclosure have been described above, the technical scope of the present disclosure is not limited to the embodiments described above as it is, and various modifications can be made without departing from the gist of the present disclosure. In addition, constituent elements of different embodiments and modification examples may be appropriately combined.

The present technology may also be configured as below.
(1) A memory control device comprising:
   an arbiter that accepts an access request to a memory including a plurality of bank groups each of which has a plurality of banks; and
   a memory controller that issues a command corresponding to the access request accepted by the arbiter, wherein
   in a case where the arbiter accepts an access request to a first bank group of the plurality of bank groups, the arbiter suspends acceptance of another access request to the first bank group.
(2) The memory control device according to (1), wherein
   in a case where the arbiter accepts an access request to a bank group other than the first bank group, the arbiter cancels the suspension.
(3) The memory control device according to (1) or (2), wherein
   the arbiter
   starts a count indicating that the first bank group is in a busy state in a case where the arbiter accepts the access request to the first bank group, and
   cancels the suspension in a case where a value of the count reaches a predetermined value.
(4) The memory control device according to any one of (1) to (3), comprising
   a FIFO that accumulates the access request accepted by the arbiter, wherein
   the memory controller extracts the access request accumulated in the FIFO and issues a command corresponding to the access request extracted, and
   the arbiter cancels the suspension in a case where a data amount of the access request accumulated in the FIFO falls below a predetermined data amount.
(5) The memory control device according to any one of (1) to (4), wherein
   the arbiter calculates, at least for each bank group, an assertion period from when the access request is made to when the access request is accepted, and
   in a case where issuance of commands corresponding to a plurality of access requests collides with each other, the memory controller preferentially issues a command corresponding to any one of the access requests on a basis of a calculated value for the assertion period calculated by the arbiter.
(6) The memory control device according to (5), wherein
   the memory controller preferentially issues, among the plurality of access requests, a command corresponding to the access request having a largest calculated value for the assertion period.
(7) The memory control device according to (5) or (6), wherein
   the arbiter calculates the assertion period for each bank.
(8) The memory control device according to any one of (1) to (7), wherein
   the arbiter accepts an access request for which a burst length results in having a first burst length and an access request for which the burst length results in having a second burst length longer than the first burst length in this order, the burst length being for a burst transfer performed when data is written to the memory and data is read from the memory.
(9) The memory control device according to (8), wherein
   the arbiter accepts the access request for which the burst length results in having the first burst length and the access request for which the burst length results in having the second burst length in this order, on a basis of an address, a data width and length indicated in the access request.
(10) A memory control method comprising:
   accepting, by an arbiter, an access request to a memory including a plurality of bank groups each of which has a plurality of banks; and
   issuing, by a memory controller, a command corresponding to the access request accepted by the arbiter, wherein
   in a case where the arbiter accepts an access request to a first bank group of the plurality of bank groups, the arbiter suspends acceptance of another access request to the first bank group.

### REFERENCE SIGNS LIST

10 MEMORY
20 MEMORY CONTROL DEVICE
21 ARBITER
22 FIFO
23 MEMORY CONTROLLER
100 MEMORY CONTROL SYSTEM
M MASTER

1. A memory control device comprising:
an arbiter that accepts an access request to a memory including a plurality of bank groups each of which has a plurality of banks; and
a memory controller that issues a command corresponding to the access request accepted by the arbiter, wherein
in a case where the arbiter accepts an access request to a first bank group of the plurality of bank groups, the arbiter suspends acceptance of another access request to the first bank group.

2. The memory control device according to claim 1, wherein
in a case where the arbiter accepts an access request to a bank group other than the first bank group, the arbiter cancels the suspension.

3. The memory control device according to claim 1, wherein
the arbiter
starts a count indicating that the first bank group is in a busy state in a case where the arbiter accepts the access request to the first bank group, and
cancels the suspension in a case where a value of the count reaches a predetermined value.

4. The memory control device according to claim 1, comprising
a FIFO that accumulates the access request accepted by the arbiter, wherein
the memory controller extracts the access request accumulated in the FIFO and issues a command corresponding to the access request extracted, and
the arbiter cancels the suspension in a case where a data amount of the access request accumulated in the FIFO falls below a predetermined data amount.

5. The memory control device according to claim 1, wherein
the arbiter calculates, at least for each bank group, an assertion period from when the access request is made to when the access request is accepted, and
in a case where issuance of commands corresponding to a plurality of access requests collides with each other, the memory controller preferentially issues a command corresponding to any one of the access requests on a basis of a calculated value for the assertion period calculated by the arbiter.

6. The memory control device according to claim 5, wherein
the memory controller preferentially issues, among the plurality of access requests, a command corresponding to the access request having a largest calculated value for the assertion period.

7. The memory control device according to claim 5, wherein
the arbiter calculates the assertion period for each bank.

8. The memory control device according to claim 1, wherein
the arbiter accepts an access request for which a burst length results in having a first burst length and an access request for which the burst length results in having a second burst length longer than the first burst length in this order, the burst length being for a burst transfer performed when data is written to the memory and data is read from the memory.

9. The memory control device according to claim 8, wherein
the arbiter accepts the access request for which the burst length results in having the first burst length and the access request for which the burst length results in having the second burst length in this order, on a basis of an address, a data width and length indicated in the access request.

10. A memory control method comprising:
accepting, by an arbiter, an access request to a memory including a plurality of bank groups each of which has a plurality of banks; and
issuing, by a memory controller, a command corresponding to the access request accepted by the arbiter, wherein
in a case where the arbiter accepts an access request to a first bank group of the plurality of bank groups, the arbiter suspends acceptance of another access request to the first bank group.
